(19) United States
(12) Patent Application Publication
(10) Pub. No.: US 2017/0185092 A1
(43) Pub. Date: Jun. 29, 2017

(54) APPARATUS AND METHOD FOR DISPENSING A WASH SOLUTION FOR CONVEYING THE SAME INTO A WASHING DEVICE, CAR WASH FACILITY AND PROGRAM MEDIA

(71) Applicant: PINELINE OY, Riihimaki (FI)

(72) Inventors: Esa MÄKINEN, Riihimaki (FI); Juho ROINE, Helsinki (FI); Jukka AJO, Lahti (FI)

(21) Appl. No.: 15/455,552

(22) Filed: Mar. 10, 2017

Related U.S. Application Data
(63) Continuation of application No. PCT/FI2015/050567, filed on Sep. 1, 2015.

(30) Foreign Application Priority Data
Sep. 11, 2014 (FI) 20145791

(51) Int. Cl. G05D 11/13; B60S 3/04

(52) U.S. Cl. CPC G05D 11/133; B60S 3/04

(57) ABSTRACT

An apparatus and a method for dispensing a wash solution, conveyed into a washing device, at a desired concentration of detergent chemical. The apparatus includes a first tank for a wash solution at a desired concentration. Supply water passed through measuring elements is divided into partial flows along at least two lines. At least one line conveys detergent chemical along with water into the tank, and at least one second line supplies plain water. The apparatus includes at least one second tank, into which at least a detergent chemical-containing partial flow is conveyed into the first tank. The second tank has a first surface level sensing element which indicates the attainment of a design volume and the amount of water which has flown through the measuring elements at the indication moment and which provides a basis for determining the concentration of detergent chemical in the second tank.

### CROSS-REFERENCED TO RELATED APPLICATIONS

This application is a continuation of PCT Patent Application No. PCT/FI2015/050567 filed Sep. 1, 2015, which claims the benefit under 35 USC §119(e) to Finnish Patent Application No. 20145791, filed Sep. 11, 2014, the disclosure of each of these applications are expressly incorporated herein by reference in their entireties.

### FIELD

The present invention relates to an apparatus for dispensing a wash solution for conveying the same into a washing device, said apparatus comprising a first tank for the wash solution, said tank including elements for supplying the tank with wash water and a wash solution, elements for measuring the amount of water to be supplied into the tank, and elements for conveying the wash solution from the tank into the washing device. The invention relates also to a car wash facility. In addition, the invention relates to a method for dispensing a wash solution, made up of water and a detergent chemical and to be conveyed into a washing device, at a desired concentration of detergent chemical. A still further object of the invention is a program media.

### BACKGROUND

The current problems with car wash facilities include, among others, different wash solution concentration requirements for winter and summer seasons, which require manual adjustment procedures with resulting considerable costs. In addition, it is difficult with current systems to uphold the concentration of a wash solution due, among other things, to pressure fluctuations in the service water of each car wash facility and problems in systems warning about depleting chemical containers. Therefore, it is necessary in car wash facilities from time to time to conduct manual verifying measurements by means of a measuring cup to find out how the adjustments have held.

Thus, it is an object of the present invention to provide a reliable apparatus for dispensing a wash solution at a desired detergent concentration into a washing device. In order to attain this objective, an apparatus of the invention is characterized by what is presented in the characterizing section of claim 1. A car wash facility of the invention is characterized by what is presented in the characterizing section of the independent claim 6. A method of the invention is in turn characterized by what is presented in the characterizing section of the independent claim 7. A program media of the invention is characterized by the characterizing features presented by the independent claim 13.

### DRAWINGS

The invention will now be described more closely with reference to the accompanying drawings, in which:

FIG. 1 shows in a schematic view of principle one exemplary embodiment for an apparatus of the invention,

FIG. 2 shows one component for an apparatus of the invention in more detail in a schematic isometric view, and

FIG. 3 shows one optional embodiment for the component of FIG. 2 in a schematic side view.

### DETAILED DESCRIPTION

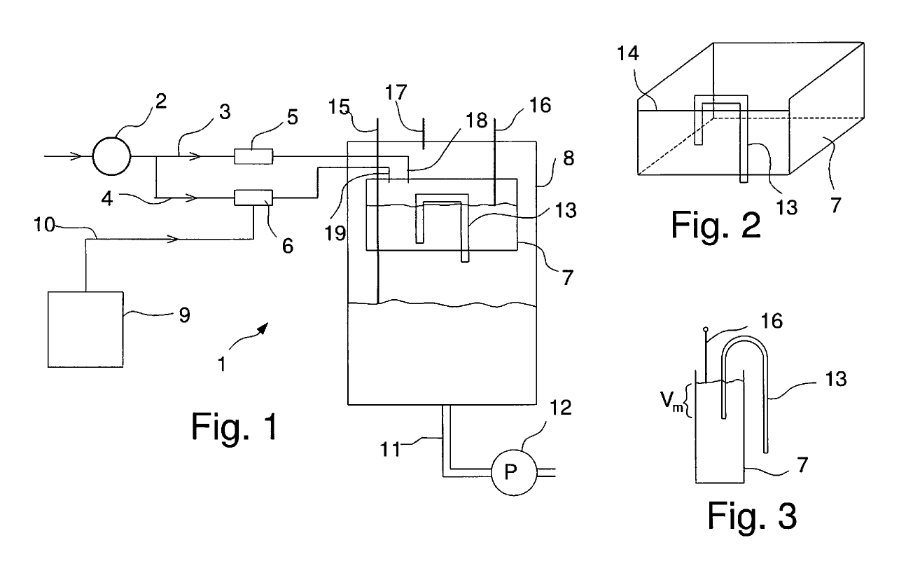

FIG. 1 shows schematically one implementation example for an apparatus 1 of the invention. The apparatus includes a first tank 8, which is used for holding a wash solution at a specific detergent concentration for conveying the same via a pipe 11 by means of a pump 12 into a washing device (not shown), which is for example a car washing device, and which is supplied with the wash solution intermittently according to a desired wash program. For various wash solutions there are provided specific dispensers, e.g. separate ones for waxing wash and solvent wash. Inside the holding tank 8 is fitted a second tank 7 which is provided with siphon means 13. The wash solution is produced by supplying water through a flow meter 2 and by dividing the flow into partial flows along lines 3 and 4, which are provided with magnetic valves 5 and 6, respectively. By controlling the valves 5 and 6, it is possible to determine the ratio and time instant for the partial flows. Downstream of the valve, each line continues to the second tank 7 as line sections 18 and 19, respectively. The valve 6 is equipped with a nozzle member (not shown), which operates on ejector principle drawing in detergent from a chemical tank 9 via a pipe 10 as water is supplied through the nozzle at a suitable pressure. The nozzle member is designed to draw in the detergent chemical at a constant ratio with respect to water supplied by way of the valve 6, for example 1 part of detergent chemical and 2 parts of water, whereby the wash solution passing along the line section 19 downstream of the valve 6 contains about 33% of detergent chemical. The detergent chemical can be in the form of a concentrate or previously admixed in water to a certain concentration, which is diluted with water in the siphon-containing tank 7 and/or in the holding tank 8. The second tank 7 is provided with a surface level sensing element 16, which is set to indicate the attainment of e.g. a 1 liter design volume in the second tank 7. The sensing element 16 comprises preferably an electrically conductive static measuring stick, which provides a signal upon coming to contact with liquid. When the sensing element 16 issues a signal about the attainment of 1 liter design volume, the flow meter 2 will be read for the amount of water that has passed therethrough, thereby enabling the amount of detergent chemical picked up from the chemical tank 9 to be calculated by subtracting the measured amount of water from the volume of 11. Once the concentration of detergent chemical in the tank 9 is known, this provides a reliable and relatively simple way of determining its concentration in a final wash solution in the tank 8. The second tank 7 is provided with a siphon 13, which enables a delivery of the wash solution into the first tank 8 as soon as the detergent chemical-containing solution has reached a volume required for activating the siphon in the second tank 7. The volume needed for activating the siphon is preferably slightly larger than the design volume, e.g. 1.2 liters.

FIG. 2 shows separately one exemplary embodiment for the second tank 7 in slightly more detail. One edge of the tank is formed with an overflow brim 14 slightly lower than the rest of the tank's edge. The siphon 13 is in this example adapted to open at one of its ends to the proximity of a floor of the tank 7 for enabling the tank to be emptied essentially completely by means of the siphon. The siphon has its other end extended through the floor of the tank 7.

The concentration of a detergent chemical in the wash solution can be determined e.g. at the start of each washing process as the sensing element 16 issues a signal about the attainment of a design volume in the second tank 7, followed by supplying water via the lines 3, 18 and 4, 19 continuously into the second tank 7, wherefrom the wash solution flows by way of both the siphon 13 and the overflow brim 14 into the first tank. The supply of water via the lines 3, 18 and 4, 19 in a continuous manner takes place at a certain ratio between partial flows which can be adjusted as necessary. The adjustment is preferably adapted to enable remote control by connecting the flow meter 2, the magnetic valves 5, 6, and the sensing element 16 to a remote control system. Thereby, it is also possible to produce alarms about various fault conditions. The continuous supply is carried on until the washing process comes to an end, at which time the second tank drains by way of the siphon. After the next washing process has started and the tank is filling up, there will be conducted another determination of concentration.

According to one option, the concentration can be determined in such a way that the second tank 7 is emptied by means of the siphon 13 always after the concentration has been determined by supplying the second tank 7 with a detergent chemical-containing partial flow and a partial flow of solely water until the siphon 13 activates. After the draining, the second tank is refilled and the process is repeated, whereby the concentration of detergent chemical in each batch is known precisely and, therefore, so is also the concentration of a wash solution present in the first tank 8.

The first tank 8 is provided with a second surface level sensing element 15, which indicates the attainment of a given design volume of wash solution in the first tank. The sensing element 15 comprises preferably an electrically conductive static measuring stick, which provides a signal upon coming to contact with liquid. This second sensing element 15 can also be utilized in the determination of a detergent chemical concentration, e.g. by adapting the second tank 7 to be only supplied with a detergent chemical-containing partial flow and the first tank 8 directly with a partial flow containing just water. By means of the sensing element 16 of the second tank 7 it is possible to determine the chemical concentration of a wash solution fraction present in the second tank by only feeding water initially through the magnetic valve 6 of the second line 4 while the valve 5 is closed. Once the chemical concentration in the second tank is determined, the second tank 7 shall still be supplied with a detergent chemical-containing partial flow of water required for the siphon 13 to activate. After the siphon 13 has been activated, the magnetic valve 6 will be closed and the magnetic valve 5 will be opened, whereby the first tank 8 will be supplied with water along the line 18 until the second sensing element 15 issues a signal about the attainment of a design volume in the first tank 8. The supply of water through the magnetic valve 5 is timed in such a way that the draining of the second tank 7 by means of the siphon 13 takes place prior to reaching a design volume in the first tank 8.

The first tank 8 has its upper part region, above the second tank 7, preferably provided with a third surface level sensing element 17, which is used for ensuring that the apparatus is not allowed to overflow. The sensing element 17 comprises preferably an electrically conductive static measuring stick, which provides a signal upon coming to contact with liquid. When the third sensing element 17 issues a signal about reaching an overflow alarm threshold, the supply of water is stopped immediately, e.g. by closing the magnetic valves 5 and 6.

In the foregoing embodiment, the siphon 13 has such a disposition that, after its activation, there is achieved a substantially complete draining of the second tank 7, but the siphon can also be disposed in a top edge region of the second tank as shown in FIG. 3, whereby the tank's design volume will be defined as the volume of a space Vₘ between a bottom edge of an intra-tank part of the siphon 13 and a bottom edge of the sensing element 16. Thus, it is possible that the second tank has continuously some wash solution, which is present in a zone below a bottom edge of the siphon 13 and the concentration of which has been adjusted as desired by supplying the second tank with a mixture of detergent chemical and water at a correct ratio for as long as the entire wash solution volume has been exchanged.

In the foregoing embodiment, inside the first tank 8 is disposed one second tank 7 equipped with a siphon 13, but there can be several of such second tanks within the first tank, e.g. a specific one for various detergent chemicals, whereby the supply of water may also take place along several lines as may be required by a particular detergent chemical. Plain water may also has its siphon-equipped designated tank, by means of which the flow meter can be easily calibrated by propelling plain water into the siphon-containing tank and, as the sensing element issues a signal about the attainment of a design volume, the reading given by the flow meter is checked at the same instant and the flow meter is adjusted as necessary to indicate the real design volume. The siphon-containing tanks can also be connected to each other, e.g. such that the detergent chemical-containing tank is emptied by means of the siphon into another siphon-containing tank to which opens a plain water supply line. This way is achieved effective mixing and the mixture is then conducted by means of the siphon into the first tank 8.

With a view to emptying a siphon-containing tank more effectively, the tank can be provided with more than one siphon, which can be disposed at various activation heights.

The control system for an apparatus of the invention can be implemented in a way controlled by a computer, whereby different adjustments, needed e.g. in car wash facilities in various seasons, can be carried out e.g. by making a program code which complies with the calendar in terms of adjusting the concentration little by little from a lower concentration needed in summer to a higher concentration needed in winter and again back towards a lower concentration. Typically, the detergent chemical concentration is in the order of about 5% in summer and in the order of about 30% in winter. In traditional systems, the adjustment has been made by manually swapping different size nozzles in the autumn for a winter setup and others in the spring for a summer setup. This entails that it is often necessary to run even long periods with wrong setups before managing to exchange the nozzles for a size appropriate for the season. In the autumn, this entails a poorer wash result as the concentration of a detergent chemical falls short of what is necessary in light of the conditions and in the spring, on the other hand, the consumption of a detergent chemical becomes excessive in light of the demand, thus incurring extra costs for the car wash facility. In addition, the manual swapping of nozzles leads to considerable maintenance costs and use of time for the personnel conducting the exchange.

Benefits of the foregoing invention are, among others, as follows:
detergent chemical concentration can be determined dependably and in a reliably working manner
determination of concentration and necessary corrections to concentration and changes of concentration, e.g. according to various seasons, can be conducted in a computer-controlled manner and by making use of remote control
moving actuators are not in contact with detergent chemical, thus reducing the need for maintenance
more attractive price as compared to solutions implemented by means of various control valves
no need for on-site exchange of nozzles according to various seasons
homogenizes the concentration, preventing its fluctuation
improves mixing of the material
prevents reflux into the chemical tank
enables a compact assembly
quick maintenance
reduces substantially the operating time of magnetic valves, thus increasing the longevity thereof
no moving parts in contact with detergent chemical.

Although the invention has been described above specifically in relation to car wash facilities, it is applicable also to other corresponding washing plants, such as washing facilities for trains, washing equipment for various industrial plants (e.g. meat packing companies), etc.

### LIST OF REFERENCE NUMERALS

1 dispenser
2 water meter
3, 4 water supply
5 magnetic valve
6 magnetic valve and ejector
7 siphon-equipped tank
8 wash liquid mixture holding tank
9 tank for detergent chemical
10 detergent chemical supply pipe
11 outlet pipe from wash liquid mixture tank
12 pump
13 siphon
14 siphon tank's overflow brim
15-17 surface level sensing elements
18 water supply into siphon tank
19 wash solution supply into siphon tank Vₘ design volume

1. An apparatus for dispensing a wash solution, comprising a mixture of water and a detergent chemical and to be conveyed into a washing device, at a desired concentration of the detergent chemical, said apparatus comprising a first tank for the wash solution at a desired concentration, said tank including elements for supplying the first tank with an aqueous solution of supply water and a detergent chemical, elements for measuring the total amount of supply water, and elements for conveying the wash solution at a desired concentration from the first tank into a washing device, wherein the supply water passed through measuring elements is divided into partial flows along at least two lines, which are provided with valve elements for adjusting the partial flows of supply water at a desired ratio between the lines; that at least one line for the partial flows of supply water is connected to a detergent chemical supply for conveying the detergent chemical along with water into the tank and at least one second line is intended for the supply of plain water; that the apparatus includes at least one second tank which is in a flow communication with the first tank by way of a siphon element, whereby at least the detergent chemical-containing partial flow is adapted to be conveyed into said second tank and to be conducted further into the first tank as soon as the detergent chemical-containing solution present in the second tank has attained a volume required for the siphon to activate; that the second tank is provided with a first surface level sensing element, which indicates the attainment of a certain design volume in the second tank, whereby the water quantity measuring elements register an indication moment which has been given by the sensing element about the attainment of a design volume, and the amount of water which has flown through the measuring elements at the indication moment and which provides a basis for determining the concentration of a detergent chemical in the second tank.

2. An apparatus according to claim 1, wherein the partial flow of supply water that has passed by way of the plain water supplying line is also conducted into the second tank.

3. An apparatus according to claim 1, wherein the partial flow of supply water that has passed by way of the plain water supplying line is conducted directly into the first tank once a certain amount of the detergent chemical-containing water has been removed by means of the siphon into the first tank, which is provided with a second surface level sensing element indicating that the first tank has attained a certain volume of wash solution, whereby the water quantity measuring elements register the indication moment which has been given by the second sensing element, and the total amount of water which has flown by way of the measuring elements at the indication moment and which provides a basis of determining the concentration of a detergent chemical in the first tank.

4. An apparatus according to claim 1, wherein connection with the valve element, included in the line which is flow communication with a detergent chemical tank, is provided a nozzle member operating on ejector principle, such that the delivery of water through the ejector nozzle results in the detergent chemical to be drawn in from the detergent chemical tank to admix with water at a certain mixing ratio.

5. An apparatus according to claim 1, wherein the supply water measuring elements and the valve elements are connected to a remote control system by means of which the concentration of a detergent chemical in the wash solution can be adjusted as desired.

6. A car wash facility, wherein the car wash facility comprises the apparatus according to claim 1.

7. A method for dispensing a wash solution, comprising a mixture of water and a detergent chemical and to be conveyed into a washing device, at a desired concentration of detergent chemical, said method comprising the use of an apparatus which comprises a first tank for the wash solution at a desired concentration, said tank including elements for supplying the tank with an aqueous solution of supply water and a detergent chemical, elements for measuring the total amount of supply water, and elements for conveying the wash solution at a desired concentration from the first tank into a washing device, wherein the supply water passed through measuring elements is divided into at least two lines, which are each provided with valve elements by means of which partial flows of supply water are adjusted at a desired ratio between the lines; that at least one line for a partial flow of supply water is connected to a detergent chemical supply for conveying the detergent chemical along with water into the tank; said at least one line connected to the detergent chemical supply being adapted to open into a second tank which is in flow communication with the first tank, said second tank being provided with siphon elements by way of which the detergent chemical-containing partial flow of supply water is capable of being conducted into the first tank as soon as the solution of water and detergent chemical present in the second tank has attained a volume required for the siphon to activate; that the method comprises sensing, by means of a sensing element, the attainment of a certain design volume in the second tank, and the water quantity measuring elements register the indication moment which has been given by the sensing element about the attainment of a design volume, and the amount of water which has flown through the measuring elements at the indication moment and which provides a basis for determining the concentration of a detergent chemical in the second tank.

8. A method according to claim 7, wherein the method further comprises supplying the second tank also with a partial flow of supply water which has passed by way of the plain water supplying line, and determining the concentration of a detergent chemical in the second tank by means of the surface level sensing element and the water quantity measuring elements, followed by conveying the wash solution at a certain detergent chemical concentration by way of a siphon into the first tank.

9. A method according to claim 8, wherein the method further comprises propelling, after determining the concentration of a detergent chemical, water and detergent chemical by way of the lines into the second tank in continuous operation for a certain period of time, such that the wash solution passes by way of both a siphon and an overflow brim into the first tank whereby, after the supply of water has terminated, the siphon is emptied and, upon re-commencing the process, the concentration of detergent chemical can be determined again by means of the surface level sensing element of the second tank and the water quantity measuring elements.

10. A method according to claim 7, wherein the method further comprises conducting a partial flow of supply water, which has passed by way of the plain water supplying line, into the first tank after removing a certain volume of the detergent chemical-containing supply water by means of the siphon from the second tank into the first tank, said first tank being provided with a second surface level sensing element which indicates that the first tank has attained a certain volume of the wash solution, whereby the water quantity measuring elements register the indication moment given by the second sensing element, and the total amount of water which has flown through the measuring elements at the indication moment and which provides a basis for determining the concentration of a detergent chemical in the first tank.

11. A method according to claim 7, wherein the method further comprises using a remote control system by means of which the supply water measuring elements and the valve elements are controlled for determining and adjusting the concentration of a detergent chemical present in the wash solution as desired.

12. A method according to claim 7, wherein the method further comprises conveying the wash solution to a washing device included in a car wash facility.

13. A non-transitory computer readable medium storing a computer program for exution by a processor of a computer, which when executed by the processor, causes the computer to execute the method of claim 7.
